(19) United States
(12) Patent Application Publication
(10) Pub. No.: US 2025/0166481 A1
(43) Pub. Date: May 22, 2025

(54) AUTOMATED USER INTERFACE ALERTS FOR VOICE QUALITY

(71) Applicant: QUALCOMM Incorporated, San Diego, CA (US)

(72) Inventors: Sony AKKARAKARAN, Poway, CA (US); Vivek RAJENDRAN, San Diego, CA (US); Alberto RICO ALVARINO, San Diego, CA (US)

(21) Appl. No.: 18/512,829

(22) Filed: Nov. 17, 2023

(51) Int. Cl. G08B 21/18; H04B 10/079; H04B 17/336; H04L 1/1812; H04L 1/20; H04L 43/0864; H04M 3/22

(52) U.S. Cl. CPC G08B 21/182; H04B 10/07953; H04B 17/336; H04L 1/1812; H04L 1/203; H04L 43/0864; H04M 3/2236

(57) ABSTRACT

A device includes one or more processors configured to obtain data associated with a voice transmission during a communication session with a second device. The one or more processors are configured to analyze the data to generate a voice quality metric. The one or more processors are configured to, based on a determination that the voice quality metric fails to satisfy a voice quality threshold, generate an indication to a user that indicates a manner in which the user should proceed with the communication session.

### I. FIELD

The present disclosure is generally related to automated user interface alerts for voice quality.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices, such as smartphones and headset devices, often incorporate functionality to obtain data associated with a voice transmission during a communication session with a second device. For example, the computing device can receive a voice transmission during a voice-over-internet-protocol (“VoIP”) communication session.

In order to maintain a quality user experience in a VoIP communication session, a computing device may employ various strategies for maintaining call quality. For example, a voice packet in a VoIP communication session can be transmitted over a shorter-duration transmission time interval (“TTI”) than in a circuit-switched communication session, but may potentially need automatic repeat requests, forward error correction, or some combination thereof. The packet must complete transmission (including repeat requests, error correction, etc.) within a latency bound to prevent queueing of packets and excessive delay, which would be noticeable during the call. For example, during a voice communication session with excessive delay, a user can pause speaking in order to receive a reply from another participant, not receive one, and begin speaking again before the reply arrives (a “double-talk” issue).

As another example of what has been implemented to improve user experience, the computing device can attempt to meet the latency bound by transmitting the packet(s) at a higher transmission power, which can reduce the number of repeat requests. However, the higher power can drain the battery of the computing device more quickly and can also more provide interference to other users (e.g., in neighboring cells) in the system. In situations in which the link quality associated with the computing device's connection to the communication session is poor, the computing device can be power limited (i.e., have insufficient power available). In such a scenario, the computing device could switch to a lower quality voice codec with a lower bit-rate, which could operate with lower power while maintaining the delay bound.

However, these strategies can still leave a voice communication session user with a poor experience based on packet delay. For example, these strategies may be unable to prevent noticeable delays in scenarios in which there are large packet delays, inherently high-latency links to the communication session (e.g., involving a non-terrestrial network), poor channel quality, or some combination thereof.

### III. SUMMARY

According to one implementation of the subject disclosure, a device includes one or more processors configured to obtain data associated with a voice transmission during a communication session with a second device. The one or more processors can also be configured to analyze the data to generate a voice quality metric. The one or more processors can also be configured to, based on a determination that the voice quality metric fails to satisfy a voice quality threshold, generate an indication to a user that indicates a manner in which the user should proceed with the communication session.

According to another implementation of the subject disclosure, a non-transitory computer-readable medium includes instructions that, when executed by one or more processors, cause the one or more processors to obtain, at a first device, data associated with a voice transmission during a communication session with a second device. The instructions also cause the one or more processors to analyze the data to generate a voice quality metric. The instructions also cause the one or more processors to, based on a determination that the voice quality metric fails to satisfy a voice quality threshold, generate an indication to a user that indicates a manner in which the user should proceed with the communication session.

According to another implementation of the subject disclosure, a method includes obtaining, at a first device, data associated with a voice transmission during a communication session with a second device. The method also includes analyzing, at the first device, the data to generate a voice quality metric. The method also includes, based on a determination that the voice quality metric fails to satisfy a voice quality threshold, generating an indication to a user that indicates a manner in which the user should proceed with the communication session.

According to another implementation of the subject disclosure, an apparatus includes means for obtaining, at a first device, data associated with a voice transmission during a communication session with a second apparatus. The apparatus also includes means for analyzing, at the first device, the data to generate a voice quality metric. The apparatus also includes, based on a determination that the voice quality metric fails to satisfy a voice quality threshold, means for generating an indication to a user that indicates a manner in which the user should proceed with the communication session.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of an example of a system that includes an electronic device configured to provide automated user interface alerts for voice quality, in accordance with some examples of the subject disclosure.

FIG. 2 illustrates an example of an integrated circuit operable to enable automated user interface alerts for voice quality, in accordance with some examples of the present disclosure.

FIG. 3 depicts an example of a mobile device that is configured to provide automated user interface alerts for voice quality, in accordance with some examples of the present disclosure.

FIG. 4 depicts an example of a television that is configured to provide automated user interface alerts for voice quality, in accordance with some examples of the present disclosure.

FIG. 5 depicts an example of a headset device that is configured to provide automated user interface alerts for voice quality, in accordance with some examples of the present disclosure.

FIG. 6 depicts an example of a wearable electronic device, illustrated as a “smart watch,” that is configured to provide automated user interface alerts for voice quality, in accordance with some examples of the present disclosure.

FIG. 7 depicts an example of a wireless speaker and voice activated device that is configured to provide automated user interface alerts for voice quality, in accordance with some examples of the present disclosure.

FIG. 8 depicts an example of a portable electronic device that corresponds to a camera that is configured to provide automated user interface alerts for voice quality, in accordance with some examples of the present disclosure.

FIG. 9 depicts an example of a portable electronic device that corresponds to an extended reality headset (e.g., a virtual reality headset, a mixed reality headset, an augmented reality headset, or a combination thereof) that is configured to provide automated user interface alerts for voice quality, in accordance with some examples of the present disclosure.

FIG. 10 depicts an example of a vehicle, illustrated as a manned or unmanned aerial device (e.g., a package delivery drone), that is configured to provide automated user interface alerts for voice quality, in accordance with some examples of the present disclosure.

FIG. 11 depicts an example of a vehicle, illustrated as a car, that is configured to provide automated user interface alerts for voice quality, in accordance with some examples of the present disclosure.

FIG. 12 is a flow chart of an example of a method for automated user interface alerts for voice quality, in accordance with some examples of the present disclosure.

FIG. 13 is a block diagram illustrating a particular example of the electronic device of FIG. 1, in accordance with some examples of the subject disclosure.

### V. DETAILED DESCRIPTION

Aspects disclosed herein present systems and methods for automated user interface alerts for voice quality. Conventional approaches to improving a user experience during a communication session can fail in scenarios in which there are large packet delays, inherently high-latency links to the communication session (e.g., involving a non-terrestrial network), poor channel quality, or some combination thereof. The systems and methods disclosed herein describe a device that monitors for such scenarios and issues user interface alerts and guides for an improved user experience.

User interface alerts can be triggered by a combination of different types of events and metrics. For example, a user interface alert can be triggered by a block error rate (“BLER”) metric, a signal-to-noise ratio (“SNR”) metric, or some combination thereof. These metrics can account for BLER- or SNR-related issues experienced by voice packets or other packets sent/received by user equipment in a communication session. As another example, the user interface alert can be triggered by one or more packet delay metrics such as a number of hybrid automatic repeat request (“HARQ”) retransmissions, a number of radio link control (“RLC”) retransmissions, an end-to-end packet delay, or some combination thereof. As a further example, the user interface alert can be triggered by one or more voice quality metrics. To illustrate, an electronic device can be configured to analyze received, decoded voice frames for perceptual voice quality features such as an amount of background noise. As yet another example, the user interface alert can be triggered by one or more power consumption metrics such as battery level, transmission power level, etc. Still further, the user interface alert can be triggered by the type of connection that the user has to the communication session. Differences between the type of cellular connection (3G, 4G, 5G, etc.), terrestrial vs. non-terrestrial network, connection configuration details (e.g., numerology, TTI duration, etc.), or some combination thereof, can be used as triggers for the user interface alert.

In addition to the various triggers for the user interface alert(s), different types of alert(s) can be used in different circumstances. Visual alerts, auditory alerts, sensory alerts, haptic alerts, etc. can all be used to improve the user experience.

A technical advantage of the subject disclosure includes the ability for an improved electronic device to provide an improved user experience when the electronic device is receiving a voice transmission during a communication session with a second device, particularly when there are large packet delays associated with the communication session. For example, the systems and methods disclosed herein provide for an improved electronic device that allows a user to avoid a double-talk problem.

Another technical advantage of the subject disclosure includes an improved electronic device that enables improved end-to-end signaling for the electronic device in a communication session. For example, the systems and methods disclosed herein provide for an improved electronic device that allows all participants in a communication session to be aware of end-to-end link limitations.

Another technical advantage of the subject disclosure includes an improved electronic device that enables improved video calls and extended reality sessions. For example, the systems and methods disclosed herein provide for an improved electronic device that can prompt a user to change a configuration within a video call or extended reality session to better accommodate packet delays. As a particular example, the electronic device can prompt a user to change a gaming partner within an extended reality game based on a poor link, high delay, or some combination thereof. As another particular example, the electronic device can prompt a user to use a smaller screen display size for video, automatically resize display based on video quality, switch to an audio-only mode, etc.

Another technical advantage of the subject disclosure includes an improved electronic device that participates in a communication session using an over-the-top (“OTT”) application. For example, the systems and methods disclosed herein provide for an improved electronic device that can enable a user more control over a communication link when the link is not managed by the OTT application. In a particular example, a communication session over a messaging service may not be managed by the messaging service. Providing the user with control over the link can improve the user's experience.

Another technical advantage of the subject disclosure includes an improved electronic device that uses a text-to-speech application. For example, the systems and methods disclosed herein provide for an improved electronic device that can enable the user to account for communication delays caused by use of the application itself rather than delays caused by the communication link. In a particular example, when delay is caused by a first user typing, the first user's device can signal to a second user's device that typing is occurring. As an example, the typing could be due to the user being unable to speak or preferring not to speak (for example, due to being in a public venue) and instead using a text-to-speech application or service.

Systems and methods of automated user interface alerts for voice quality are disclosed, for example, in which one or more processors can obtain, at a first device, data associated with a voice transmission during a communication session with a second device. The processor(s) can analyze, at the first device, the data to generate a voice quality metric. The processor(s) can also, based on a determination that the voice quality metric fails to satisfy a voice quality threshold, generate an indication to a user that indicates a manner in which the user should proceed with the communication session.

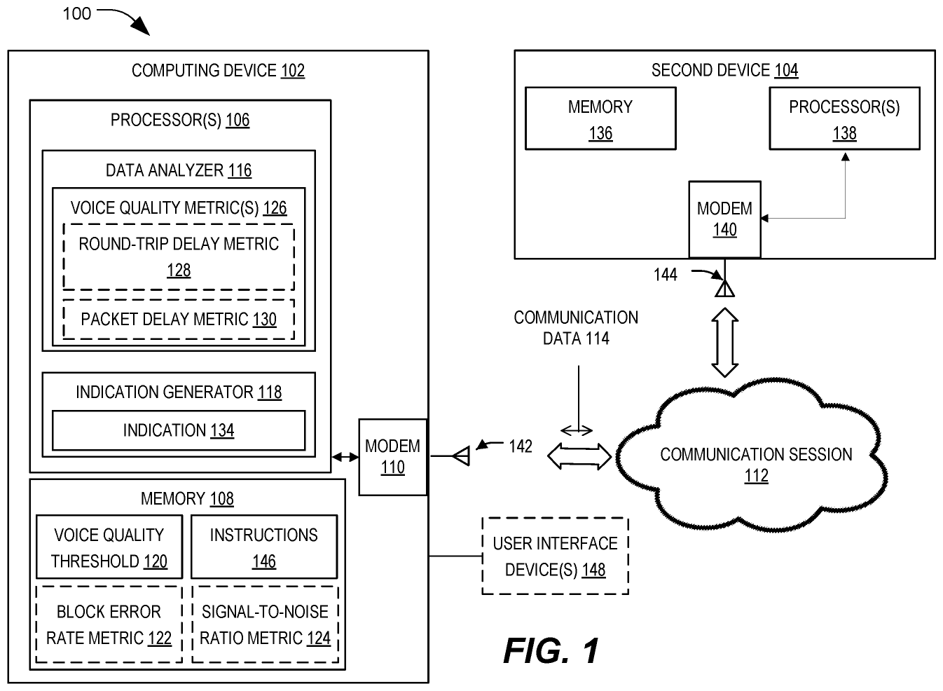

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 106 of FIG. 1), which indicates that in some implementations the device 102 includes a single processor 106 and in other implementations the device 102 includes multiple processors 106. For ease of reference herein, such features are generally introduced as “one or more” features and are subsequently referred to in the singular unless aspects related to multiple of the features are being described.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

FIG. 1 is a block diagram of an example of a system 100 that includes a computing device 102 configured to provide automated user interface alerts for voice quality, in accordance with some examples of the subject disclosure. The system 100 illustrates a computing device 102 communicating with a second device 104 via a communication session 112. The communication session 112 can be, for example, a voice call, a video gaming session, a video call, etc. Each of the computing device 102 and the second device 104 are configured to wirelessly transmit and receive data packets to one another as part of the communication session 112. Although FIG. 1 illustrates two devices in the communication session 112, more devices can be part of the communication session 112 without departing from the scope of the subject disclosure.

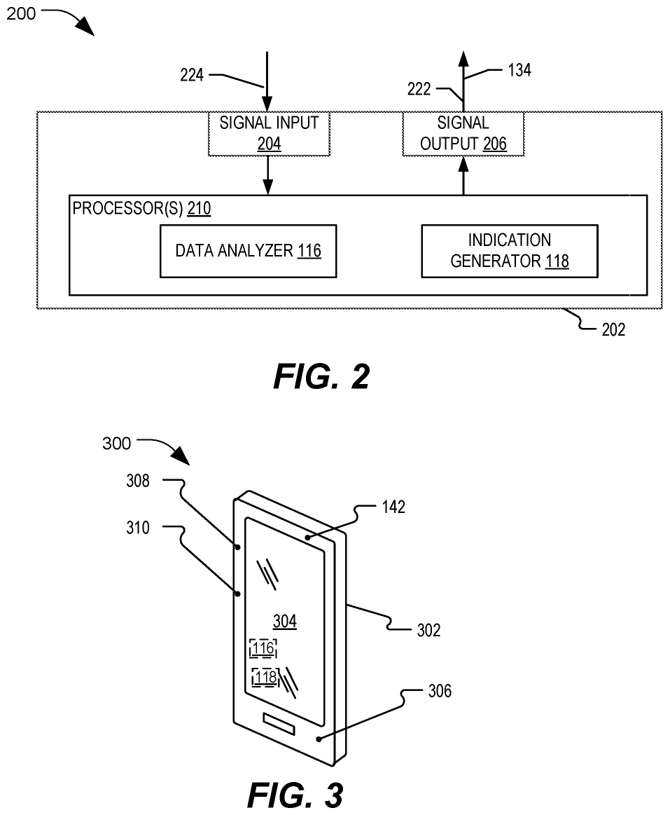

One or more second devices 104 include one or more processors 138 coupled to a memory 136. The memory 136 stores instructions for execution by the processor(s) 138 to provide functionality as described below and with reference to FIGS. 2-13. The second device 104 also includes an antenna 144 coupled to the processor(s) 138 via a modem 140. In some implementations, the second device(s) 104 correspond to a television, a mobile phone, headset device, automobile, unmanned aerial vehicle, or a tablet computing device, as illustrative, non-limiting examples.

The computing device 102 includes one or more processors 106 coupled to a memory 108. The one or more processors 106 include a data analyzer 116 and an indication generator 118. The memory 108 stores instructions 146 for execution by the processor(s) 106 to provide functionality as described below for the data analyzer 116, the indication generator 118, or a combination thereof. In some implementations, the computing device 102 corresponds to a television, a mobile phone, headset device, automobile, unmanned aerial vehicle, or a tablet computing device, as illustrative, non-limiting examples.

The computing device 102 also includes an antenna 142 coupled to the processor(s) 106 via a modem 110. The computing device 102 is configured to obtain communication data 114 associated with a transmission during a communication session 112 with the one or more second devices 104. In some aspects, the communication session 112 can include an audio call between a user of the computing device 102 and the second device(s) 104, a video call between the user of the computing device 102 and the second device(s) 104, a video game between the user of the computing device 102 and the second device(s) 104, or some combination thereof. The communication data 114 can include data associated with the content of the communication session 112, metadata associated with the communication session 112, or some combination thereof. In a particular configuration, the communication data 114 is associated with an over-the-top voice link, a text-to-speech voice data source, a voice transmission, a video call, a video gaming session, an extended reality session, or some combination thereof.

The data analyzer 116 of the processor(s) 106 analyzes the communication data 114 to generate one or more voice quality metrics 126. In some aspects, the data analyzer 116 is configured to analyze the communication data 114 according to one or more particular metrics. In a particular aspect, the data analyzer 116 is configured to analyze the communication data 114 according to a BLER metric 122, an SNR metric 124, or some combination thereof. In the same or alternative particular aspects, the data analyzer 116 is configured to analyze the communication data 114 according to one or more packet delay metrics 130, which can include a number of HARQ retransmissions, an RLC retransmission metric, an end-to-end packet delay metric, or some combination thereof.

In some aspects, the data analyzer 116 is configured to analyze the communication data 114 according to a signal quality metric that includes a perceptual speech quality metric. Such metrics can include one or more of the perceptual evaluation of speech quality (“PESQ”) family of metrics, one or more of the perceptual objective listening quality analysis (“POLQA”) family of metrics, etc. In the same or alternative aspects, the data analyzer 116 is configured to analyze the communication data 114 according to a signal quality metric that does not require a reference signal. To illustrate, the exemplary perceptual speech quality metrics described above require a reference signal. Others, such as one or more of the auditory non-intrusive quality estimation (“ANIQUE”) family of metrics, do not.

As noted above, the data analyzer 116 is configured to analyze the communication data 114 to generate the voice quality metric(s) 126. The voice quality metric(s) 126 can include one or more metrics associated with the quality of a voice received at the computing device 102 as part of the communication session 112. For example, the voice quality metric(s) 126 can include a round-trip delay metric 128 associated with a time delay for a voice packet to travel from the computing device 102 to the second device(s) 104 and back, a number of packet retransmissions, other appropriate voice quality metric(s) 126, or some combination thereof.

The processor(s) 106 are also configured to determine whether the voice quality metric(s) 126 satisfy one or more voice quality thresholds 120 stored at the memory 108. The voice quality threshold(s) 120 can include data associated with one or more threshold values used to determine whether a voice call is of sufficiently high quality, as described in more detail below.

In some aspects, the voice quality metric(s) 126 includes a number of packet retransmissions, and the voice quality threshold 120 corresponds to a retransmission threshold. The retransmission threshold can be based at least on a number of packet retransmissions during a packet window. The packet window can include a quantity of the most recently transmitted packets of a fifth-generation (“5G”) cellular communication session. In such a configuration, the retransmission threshold can be satisfied based on retransmission of a portion of the quantity of the most recently transmitted packets. For example, the retransmission threshold can be satisfied when forty of the one hundred most recently transmitted packets were retransmitted. As other non-limiting examples, the retransmission threshold can be satisfied when ten of the last fifty most recently transmitted packets were retransmitted, when forty of the last two hundred most recently transmitted packets were retransmitted, when eighty of the last two hundred most recently transmitted packets were retransmitted, etc. In some implementations, the retransmission threshold can vary based at least on a numerology associated with the communication session 112.

In a particular aspect, the processor(s) 106 can be configured to analyze the communication data 114 to determine a number of packet retransmissions. If the number of packet retransmissions satisfies the retransmission threshold, the processor(s) 106 can generate an indication 134 to a user of the computing device 102. For example, the indication 134 can include an alert to the user to adjust to a higher delay scenario.

In the same or alternative aspects, the voice quality metric(s) 126 include a round-trip delay metric, and the voice quality threshold corresponds to a round-trip delay threshold. The round-trip delay metric can be based on a time between a last transmitted packet from the computing device 102 to a particular second device 104 and a first received voice packet at the computing device 102 from the particular second device 104, in addition to a response time associated with the particular second device 104. The response time associated with the particular second device 104 can be based on a time elapsed between a last received packet at the particular second device 104 from the computing device 102 and a first transmitted packet at the particular second device 104 to the computing device 102 following the last received packet.

In a particular aspect, the processor(s) 106 can be configured to analyze the communication data 114 to detect when the user of the computing device 102 has stopped talking during the communication session 112. Based on detecting that the user has stopped talking and that the round-trip delay metric 128 satisfies the round-trip delay threshold, the processor(s) 106 can be configured to display the indication 134 as a prompt for the user to wait before resuming talking. The indication 134 can be displayed, for example, for a duration that is based on the round-trip delay metric 128. In some configurations, the duration can be based on a user-specific buffer period based on at least one of a response time of a user of the computing device 102 or a communication session configuration for the user.

The indication generator 118 of the processor(s) 106, based on a determination that the voice quality metric(s) 126 fail to satisfy one or more voice quality thresholds 120, can therefore generate one or more indications 134 to a user that indicate a manner in which the user should proceed with the communication session 112. When multiple metrics and/or thresholds are applied, the indication generation may depend on a combination of the outcomes, for example, if a certain number of thresholds are failed, or certain specific combinations of thresholds are failed. For the purposes of the subject disclosure, the voice quality metric(s) 126 can fail to satisfy the voice quality threshold(s) 120 if the voice quality metric(s) 126 are above or below the particular voice quality threshold(s) 120, depending on the particular configuration. For example, if a particular voice quality threshold 120 indicates that voice quality should have a round-trip delay of less than fifty milliseconds, a voice quality metric 126 that indicates a voice quality of sixty milliseconds (i.e., greater than the voice quality threshold) would fail to satisfy the particular voice quality threshold 120. In the same or alternative configurations, a particular voice quality threshold 120 can indicate that voice quality should have a voice quality of at least five on a ten-point rating scale. If a particular voice quality metric 126 indicates that voice quality only scores a three on the ten-point rating scale (i.e., less than the voice quality threshold), the particular voice quality metric 126 would fail to satisfy the particular voice quality threshold 120.

In some aspects, the indication(s) 134 include an alert. The alert can include one or more audio alerts, visual alerts, haptic alerts, other appropriate alerts, or some combination thereof. In the same or alternative aspects, the indication(s) 134 can include an instruction to the user. The instruction can include, for example, text indicating to the user how to proceed, graphics, audio, haptic alerts, or some combination thereof. For example, the instruction can include an instruction associated with transmission of additional audio data from the computing device 102. As another example, the instruction can include an instruction for the user to delay transmission of additional audio data from the computing device 102. As a further example, the instruction can include an instruction for the user to extend a period of nontransmission of audio data from the computing device 102.

In a still further example, the instruction can be based on a type of user activity. The type of user activity can include, for example, a video call, video game, or audio calls. In a particular configuration, the instruction for a video call can include an instruction to the user to switch to audio only for a lower latency. In another particular configuration, the instruction for a video game can include an instruction to the user to switch to a different video game server to improve latency. The user activity may be directly related to the service for which the voice quality is being analyzed, and/or may be other activity on the user's device, such as background tasks (such as a file download) running concurrently which may be impacting the voice quality. In yet another particular configuration, the instruction for an audio call can include an instruction for the user to delay transmission of additional audio data.

In some implementations, the computing device 102 can also be configured to communicate the indication(s) 134 from the computing device 102 to the second device 104. For example, the computing device 102 can communicate data associated with the indication(s) 134 to the second device 104 indicating that the user of the computing device 102 has been instructed how to proceed with the communication session 112. In some aspects, this exchange of indication(s) 134 can occur both ways. For example, the computing device 102 can receive an indication from the second device 104 indicating how the user of the second device 104 has been instructed to proceed with the communication session 112. In a particular aspect, the processor(s) 106 of the computing device 102 can be configured to generate the indication(s) 134 at the computing device 102 based on a second indication received from the second device. For example, the indication 134 at the computing device 102 can generate an indication instructing the user of the computing device 102 to switch to a higher delay scenario, where the indication is triggered by receipt of a second indication from the second device 104 indicating that the round-trip delay for the second device 104 exceeds a particular round-trip delay threshold for the second device 104. An example of a higher delay scenario is the switching of the call from a terrestrial to a non-terrestrial/satellite network at one or both ends of the call, for example, due to outage, congestion or other performance impacts in the terrestrial network.

In operation, user interface alerts can be triggered by one or more events associated with the user's interaction with the communication session 112. The computing device 102 can continuously monitor data associated with a voice transmission, analyze the data to generate a voice quality metric, and based on that voice quality metric, generate an indication informing the user of how to proceed with the communication session 112. As an exemplary operation, a user on a 5G voice call can have an associated HARQ retransmission rate greater than a retransmission threshold for more than forty of the last one hundred voice packets. The retransmission threshold can depend on numerology associated with the particular communication session 112. For example, the retransmission threshold can be lower for a 30-kHz signal (0.5 ms per slot) and larger for a 120-kHz signal (0.125 ms per slot). The computing device 102 can be configured to generate the indication 134 informing the user to adjust to a higher delay scenario.

As another exemplary operation, the computing device 102 can detect when the user stops talking and display one or more prompts to signal the user to wait before continuing. The prompt can include text (e.g., “please wait”), iconography (e.g., an ellipsis, a stop sign, etc.), or some combination thereof. The prompt can depend on the state of the user's device, such as its battery level, whether or not the user is holding the phone to the user's ear, whether the speakerphone or a peripheral device such as a wired or wireless (e.g., Bluetooth) headset is being used, etc. The prompt may be displayed on the primary device and/or one or more peripheral devices, and may depend on the capabilities of these devices (e.g., some peripheral devices may not support haptic alerts). The prompt can be displayed to the user for a duration equal to a round-trip delay plus a user-specific buffer period (e.g., 5 ms). The user-specific buffer period can be based on, for example, at least one of a response time of the user or a communication session configuration for the user. The round-trip delay can be determined from timing data associated with a plurality of voice packets, a ping test to the second device 104, or some combination thereof. For example, the round-trip delay for a voice packet at the computing device 102 can be generated based on a time elapsed between the last sent voice packet and the first received voice packet, less the response time of the second device 104. The response time of the second device 104 can be obtained based on a time elapsed between the last received voice packet at the second device 104 and the first transmitted voice packet at the second device 104.

As another exemplary operation, the communication session 112 can include one or more devices communicating via a push-to-talk communication mode. In such operation, a user can have a higher tolerance for delay given the half-duplex nature of communication. The prompt can include text, iconography, etc., indicating that the user should switch between a standard voice communication mode and a push-to-talk mode. In scenarios where delay exceeds a user's heightened expectation in the push-to-talk mode (e.g., a scenario in which the communication session 112 includes communication using a narrowband internet of things over non-terrestrial network with a geostationary satellite), the computing device 102 can be configured to generate the indication(s) 134 based on a relatively larger round-trip delay metric 128 than the round-trip delay metric 128 in the standard voice communication mode.

Other aspects of the system 100 can be present without departing from the scope of the subject disclosure. For example, the system 100 can include one or more user interface devices 148. The user interface device(s) 148 can include a display device (e.g., a display screen), an audio device (e.g., one or more speakers), a haptic device, or any combination thereof. The user interface device(s) 148 can be incorporated into the computing device 102, communicatively coupled to the computing device 102, or some combination thereof. The user interface device(s) 148 can be configured to deliver the indication(s) 134 to a user of the computing device 102. For example, a speaker can be configured to provide the indication(s) 134 via an audible signal, a haptic device can be configured to provide the indication(s) 134 via a haptic signal, a display device can be configured to provide the indication(s) 134 via a visual signal, or some combination thereof.

Although the computing device 102 is described as a television, mobile phone, or a tablet computing device, in other implementations the device 102 includes or corresponds to one or more other types of electronic device, such as a wearable electronic device, a vehicle, a voice activated device, an audio device, a wireless speaker and voice activated device, a portable electronic device, a car, a vehicle, a computing device, a communication device, an internet-of-things (IoT) device, a virtual reality (VR) device, an augmented reality (AR) device, a mixed reality (MR) device, a smart speaker, a mobile computing device, a mobile communication device, a smart phone, a laptop computer, a computer, a personal digital assistant, a display device, a gaming console, an appliance, a music player, a radio, a digital video player, a digital video disc (DVD) player, a tuner, a camera, a navigation device, any other appropriate electronic device that can operate to provide automated user interface alerts for voice quality, or a combination thereof.

Thus, the system 100 can enable automated user interface alerts for voice quality. For example, operation of the data analyzer 116 to determine the voice quality metric(s) 126 and to perform one or more comparisons to corresponding voice quality threshold(s) 120 can enable to the computing device 102 to determine, when in a high-delay scenario, to alert the user to assert user control over the communication session 112. Particularly in configurations in which the network on which the computing device 102 relies for connection is not actively controlling the communication session 112, enabling greater user control over the communication session 112 can lead to an improved user experience.

As another example, operation of the indication generator 118, responsive to detecting a high-delay scenario associated with the communication session 112, enables the computing device 102 to alert the user and, in some implementations, instruct the user to take action (or refrain from action) to alleviate or avoid voice quality issues arising from the high-delay conditions. As a result, the improved computing device 102 provides the advantage of informing the user of potential voice quality issues, allowing the user to reduce or eliminate issues such as a double-talk problem.

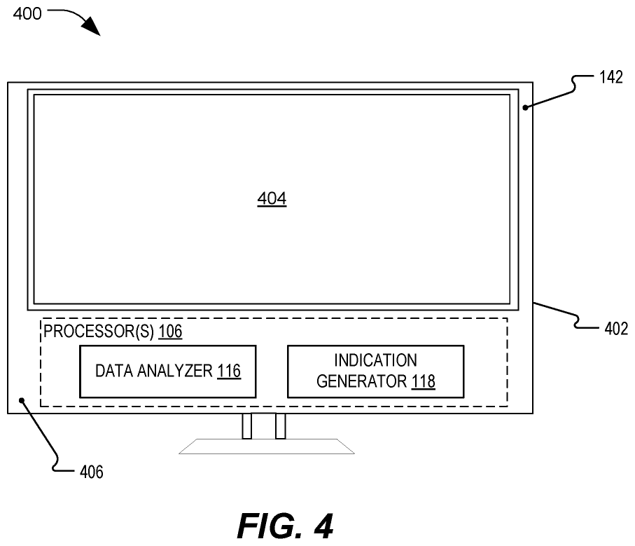

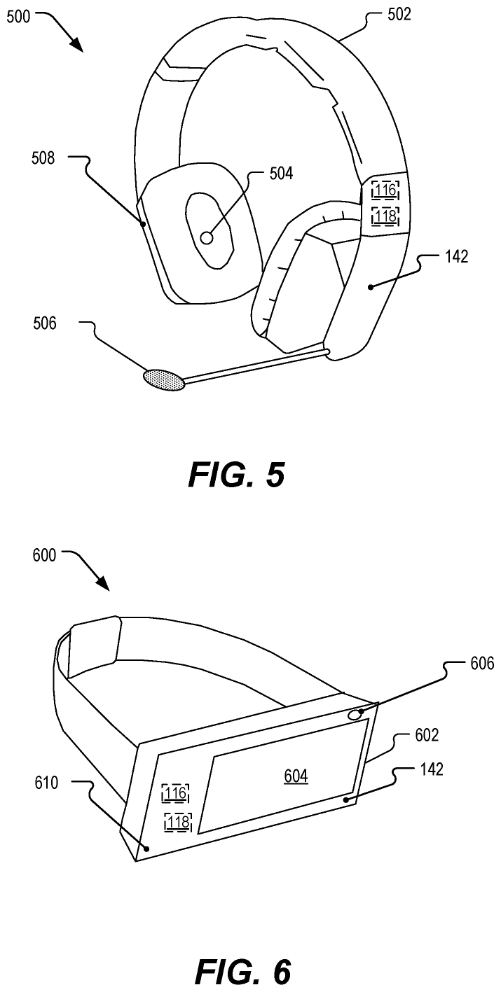

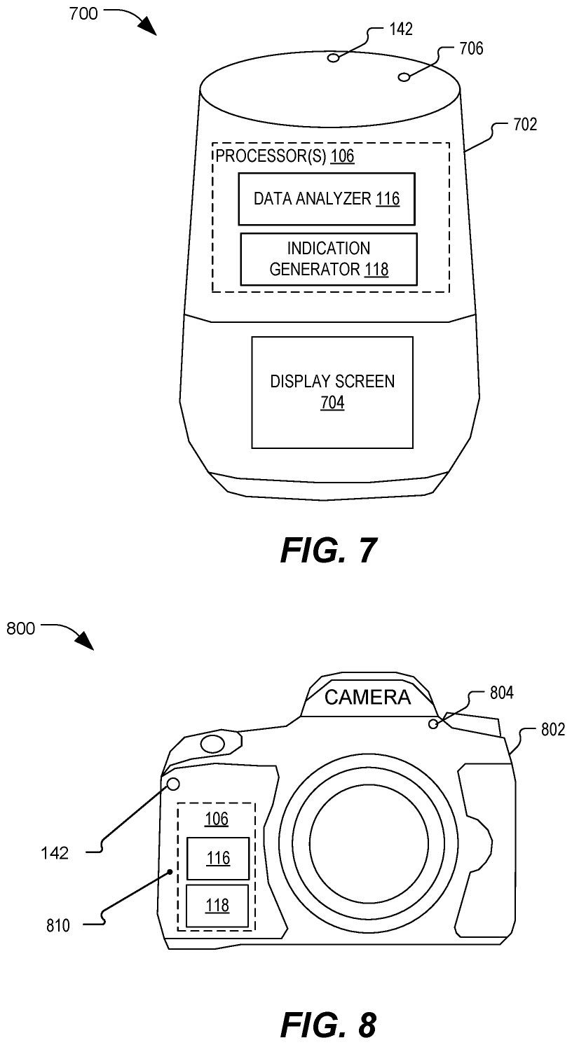

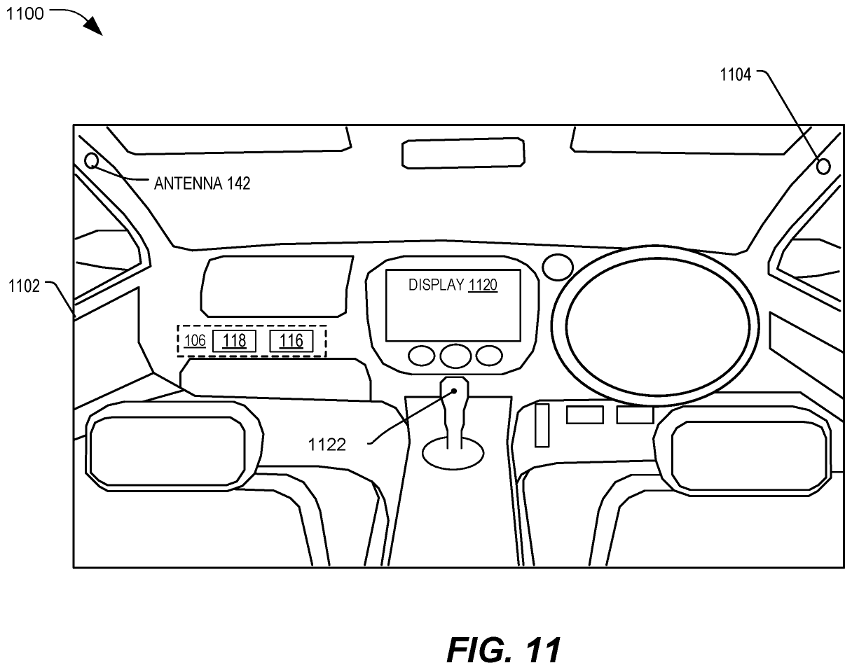

FIG. 2 depicts an implementation 200 of the computing device 102 as an integrated circuit 202 that includes one or more processors 210, such as the processor(s) 106, that include the data analyzer 116, the indication generator 118, or a combination thereof. The integrated circuit 202 also includes a signal input 204, such as one or more bus interfaces, to enable a wireless transmission 224 to be received for processing. The integrated circuit 202 also includes a signal output 206, such as a bus interface, to enable sending of an output signal, such as audio data 222, the indication(s) 134 of FIG. 1, or some combination thereof. For example, in some implementations, the wireless transmission 224 corresponds to the communication data 114 received by the antenna 142 of FIG. 1, and the audio data 222 corresponds to the data output from the computing device 102 to the communication session 112 of FIG. 1. The integrated circuit 202 enables implementation of improved automated user interface alerts for voice quality as a component in a system in which an indication is generated to indicate a manner in which a user of a computing device should proceed with a communication session, such as in a mobile phone or tablet as depicted in FIG. 3, a television as depicted in FIG. 4, a headset as depicted in FIG. 5, a wearable electronic device as depicted in FIG. 6, a voice-controlled speaker system as depicted in FIG. 7, a camera as depicted in FIG. 8, a virtual reality, mixed reality, or augmented reality headset as depicted in FIG. 8, or a vehicle as depicted in FIG. 10 or FIG. 11.

In the examples of FIGS. 3-11, various components can be illustrated with dashed lines, indicating that the component(s) are integrated with the various examples, and may not be generally visible to users. For example, FIG. 3 described in more detail below illustrates the data analyzer 116 and the indication generator 118. These components can be integrated into the mobile device 302 on one or more processors of the mobile device 302 and are illustrated using dashed lines to indicate internal components that are not generally visible to a user of the mobile device 302.

FIG. 3 depicts an implementation 300 in which the computing device 102 includes a mobile device 302, such as a phone or tablet, as illustrative, non-limiting examples. The mobile device 302 includes the antenna(s) 142 and a display screen 304. Components of the processor(s) 106 of FIG. 1, including the data analyzer 116, the indication generator 118, or a combination thereof, are integrated in the mobile device 302. In a particular example, the antenna(s) 142 may receive data (e.g., the communication data 114 of FIG. 1) from a second device (e.g., the second device 104 of FIG. 1). The data analyzer 116 can analyze the data, and the indication generator 118 can generate an indication to a user of the device 102 that indicates a manner in which the user should proceed with the communication session, as described in more detail above with reference to FIGS. 1-2.

In some implementations, the mobile device 302 can also include a speaker 308, a haptic device 310, or some combination thereof. The indication(s) 134 generated at the indication generator 118 can be provided to one or more of the display screen 304, the speaker 308, the haptic device 310, or some combination thereof to communicate the indication(s) 134 to the user of the mobile device 302.

In some implementations, the mobile device 302 can also include a microphone 306 coupled to the processor(s) 106 of FIG. 1. The microphone 306 can be configured to receive a voice signal from the user of the mobile device 302. The processor(s) 106 can be configured to transmit data associated with the received voice signal as part of a communication session (e.g., the communication session 112 of FIG. 1), such as via the antenna(s) 142.

FIG. 4 depicts an implementation 400 in which the computing device 102 corresponds to, or is integrated within, a television 402. The television 402 includes the antenna(s) 142 and a display screen 404. In some implementations, the television 402 can be configured to receive and/or transmit the communication data 114 via a wired connection (e.g., a cable coupled to the television 402). In such implementations, the antenna(s) 142 can be omitted.

Components of the processor(s) 106 of FIG. 1, including the data analyzer 116, the indication generator 118, or a combination thereof, are integrated in the television 402. In a particular example, the antenna(s) 142 may receive a wireless transmission (e.g., the wireless transmission 224 of FIG. 2) and obtain data associated with a voice transmission during a communication session with a second device. The data analyzer 116 can analyze the data to generate a voice quality metric. The indication generator 118 can generate an indication to a user of the television 402 that indicates a manner in which the user should proceed with the communication session, as described in more detail above with reference to FIGS. 1-3.

In some implementations, the television 402 can also include a speaker 406. The indication(s) 134 generated at the indication generator 118 can be provided to one or more of the display screen 404, the speaker 406, or some combination thereof to communicate the indication(s) 134 to the user of the television 402.

FIG. 5 depicts an implementation 500 in which the computing device 102 corresponds to, or is integrated within, a headset device 502. The headset device 502 includes the antenna(s) 142 of FIG. 1, one or more speakers 504, and a microphone 506. Components of the processor(s) 106 of FIG. 1, including the data analyzer 116, the indication generator 118, or some combination thereof, are integrated in the headset device 502. In a particular example, the antenna 142 may receive a wireless transmission (e.g., the wireless transmission 224 of FIG. 2) and obtain data associated with a voice transmission during a communication session with a second device. The data analyzer 116 can analyze the data to generate a voice quality metric. The indication generator 118 can generate an indication to a user of the headset device 502 that indicates a manner in which the user should proceed with the communication session, as described in more detail above with reference to FIGS. 1-4.

In some implementations, the headset device 502 can also include a haptic device 508. The indication(s) 134 generated at the indication generator 118 can be provided to one or more of the speaker(s) 504, the haptic device 508, or some combination thereof to communicate the indication(s) 134 to the user of the headset device 502.

FIG. 6 depicts an implementation 600 in which the computing device 102 includes a wearable electronic device 602, illustrated as a “smart watch.” The wearable electronic device 602 includes the antenna(s) 142 of FIG. 1, a display 604, and one or more speakers 606. Components of the processor(s) 106 of FIG. 1, including the data analyzer 116, the indication generator 118, or some combination thereof, are integrated in the wearable electronic device 602. In a particular example, the antenna 142 may receive a wireless transmission (e.g., the wireless transmission 224 of FIG. 2) and obtain data associated with a voice transmission during a communication session with a second device. The data analyzer 116 can analyze the data to generate a voice quality metric. The indication generator 118 can generate an indication to a user of the wearable electronic device 602 that indicates a manner in which the user should proceed with the communication session, as described in more detail above with reference to FIGS. 1-5.

In some implementations, the wearable electronic device 602 can also include a haptic device 610. The indication(s) 134 generated at the indication generator 118 can be provided to one or more of the display 604, the speaker(s) 606, the haptic device 610, or some combination thereof to communicate the indication(s) 134 to the user of the wearable electronic device 602.

FIG. 7 depicts an implementation 700 in which the computing device 102 includes a wireless speaker and voice activated device 702. The wireless speaker and voice activated device 702 can have wireless network connectivity and is configured to execute an assistant operation. The wireless speaker and voice activated device 702 includes the antenna(s) 142 of FIG. 1. The wireless speaker and voice activated device 702 can also include a display screen 704 and one or more speakers 706. Components of the processor(s) 106 of FIG. 1, including the data analyzer 116, the indication generator 118, or some combination thereof, are integrated in the wireless speaker and voice activated device 702. In a particular example, the antenna 142 may receive a wireless transmission (e.g., the wireless transmission 224 of FIG. 2) and obtain data associated with a voice transmission during a communication session with a second device. The data analyzer 116 can analyze the data to generate a voice quality metric. The indication generator 118 can generate an indication to a user of the wireless speaker and voice activated device 702 that indicates a manner in which the user should proceed with the communication session, as described in more detail above with reference to FIGS. 1-6. In some implementations, the indication(s) 134 generated at the indication generator 118 can be provided to one or more of the display screen 704, the speaker(s) 706, or some combination thereof to communicate the indication(s) 134 to the user of the wireless speaker and voice activated device 702.

In some implementations, voice activation functionality associated with the wireless speaker and voice activated device 702 can be implemented in a distributed manner. For example, the wireless speaker and voice activated device 702 can capture speech from a user, encode the speech, and transmit the encoded speech via a network to one or more components configured to analyze the encoded speech for an appropriate response, convert the appropriate response to encoded voice response data, and communicate the encoded voice response data to the wireless speaker and voice activated device 702 for output. In these and other examples, a double-talk issue can arise for communication with one or more non-human participants.

FIG. 8 depicts an implementation 800 in which the computing device 102 is integrated into or includes a portable electronic device that corresponds to a camera 802. The camera 802 includes the antenna(s) 142 of FIG. 1. Components of the processor(s) 106 of FIG. 1, including the data analyzer 116, the indication generator 118, or some combination thereof, are integrated in the camera 802. In a particular example, the antenna 142 may receive a wireless transmission (e.g., the wireless transmission 224 of FIG. 2) and obtain data associated with a voice transmission during a communication session with a second device. The data analyzer 116 can analyze the data to generate a voice quality metric. The indication generator 118 can generate an indication to a user of the camera 802 that indicates a manner in which the user should proceed with the communication session, as described in more detail above with reference to FIGS. 1-7.

In some implementations, the camera 802 can also include a display, a haptic device 810, one or more speakers 804, or some combination thereof. The indication(s) 134 generated at the indication generator 118 can be provided to one or more of the display, the speaker(s) 804, the haptic device 810, or some combination thereof to communicate the indication(s) 134 to the user of the camera 802.

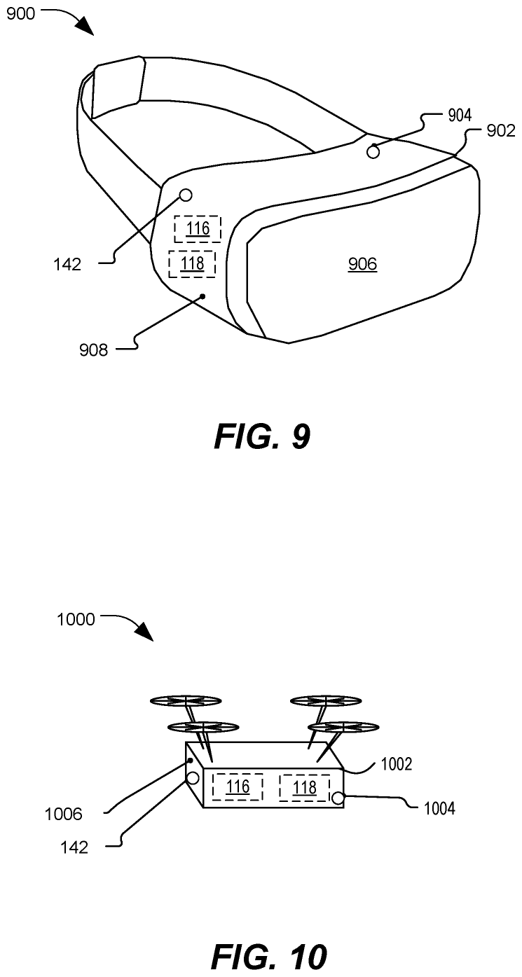

FIG. 9 depicts an implementation 900 in which the computing device 102 is a portable electronic device that corresponds to an extended reality headset 902 (e.g., a virtual reality headset, a mixed reality headset, an augmented reality headset, or a combination thereof). The extended reality headset 902 includes the antenna(s) 142 of FIG. 1. Components of the processor(s) 106 of FIG. 1, including the data analyzer 116, the indication generator 118, or some combination thereof, are integrated in the extended reality headset 902. In a particular example, the antenna 142 may receive a wireless transmission (e.g., the wireless transmission 224 of FIG. 2) and obtain data associated with a voice transmission during a communication session with a second device. The data analyzer 116 can analyze the data to generate a voice quality metric. The indication generator 118 can generate an indication to a user of the extended reality headset 902 that indicates a manner in which the user should proceed with the communication session, as described in more detail above with reference to FIGS. 1-8. For example, the indication 134 of FIG. 1 can indicate to a user that the user should switch teammates during a gaming session in order to have reduced audio lag.

In some implementations, the extended reality headset 902 can also include a display 906, a haptic device 908, one or more speakers 904, or some combination thereof. The indication(s) 134 generated at the indication generator 118 can be provided to one or more of the display 906, the speaker(s) 904, the haptic device 908, or some combination thereof to communicate the indication(s) 134 to the user of the extended reality headset 902.

FIG. 10 depicts an implementation 1000 in which the device 102 corresponds to, or is integrated within, a vehicle 1002, illustrated as a manned or unmanned aerial device (e.g., a remote communication drone). The vehicle 1002 includes the antenna(s) 142 of FIG. 1. Components of the processor(s) 106 of FIG. 1, including the data analyzer 116, the indication generator 118, or some combination thereof, are integrated in the vehicle 1002. In a particular example, the antenna 142 may receive a wireless transmission (e.g., the wireless transmission 224 of FIG. 2) and obtain data associated with a voice transmission during a communication session with a second device. The data analyzer 116 can analyze the data to generate a voice quality metric. The indication generator 118 can generate an indication to a user of the vehicle 1002 that indicates a manner in which the user should proceed with the communication session, as described in more detail above with reference to FIGS. 1-9.

In some implementations, the vehicle 1002 can also include a display 1006, one or more speakers 1004, or some combination thereof. The indication(s) 134 generated at the indication generator 118 can be provided to one or more of the display 1006, the speaker(s) 1004, or some combination thereof to communicate the indication(s) 134 to the user of the vehicle 1002. For example, an unmanned aerial vehicle used for deliveries can include capabilities for a delivery recipient to communicate with a customer service representative via the display 1006, speaker(s) 1004, etc. The indication(s) 134 generated at the indication generator 118 can enable the delivery recipient to lower latency-related issues during the communication session with the customer service representative.

FIG. 11 depicts an implementation 1100 in which the device 102 corresponds to, or is integrated within, a vehicle 1102, illustrated as a car. The vehicle 1102 includes the antenna(s) 142 of FIG. 1 and one or more speakers 1104. The vehicle 1102 can also include a display screen 1120. Components of the processor(s) 106 of FIG. 1, including the data analyzer 116, the indication generator 118, or some combination thereof, are integrated in the vehicle 1102. In a particular example, the antenna 142 may receive a wireless transmission (e.g., the wireless transmission 224 of FIG. 2) and obtain data associated with a voice transmission during a communication session with a second device. The data analyzer 116 can analyze the data to generate a voice quality metric. The indication generator 118 can generate an indication to a user of the vehicle 1102 that indicates a manner in which the user should proceed with the communication session, as described in more detail above with reference to FIGS. 1-10.

In some implementations, the vehicle 1102 can also include a haptic device 1122. The indication(s) 134 generated at the indication generator 118 can be provided to one or more of the display screen 1120, the speaker(s) 1104, the haptic device 1122, or some combination thereof to communicate the indication(s) 134 to the user of the vehicle 1102. In such a manner the vehicle 1102 can be used to, for example, provide automated user interface alerts for voice quality to a plurality of users within the vehicle 1102, such as via the display screen 1120 and/or via the speaker(s) 1104, where the vehicle 1102 can allow a user to experience an improved communication session within the vehicle 1102.

Devices (e.g., those previously mentioned in FIGS. 1-11) may have both BLUETOOTH and WI-FI® capabilities (WI-FI is a registered trademark of the Wi-Fi Alliance Corp., a California corporation), or other wireless mechanisms to communicate with each other. Inter-networked devices may have wireless mechanisms to communicate with each other and may also be connected based on different cellular communication systems, such as, a Long Term Evolution (LTE) system, a Code Division Multiple Access (CDMA) system, a Global System for Mobile Communications (GSM) system, a wireless local area network (WLAN) system, or some other wireless system. A CDMA system may implement Wideband CDMA (WCDMA), CDMA 1×, Evolution-Data Optimized (EVDO), Time Division Synchronous CDMA (TD-SCDMA), or some other version of CDMA. As used herein, “wireless” refers to one or more of the above-listed technologies, one or more other technologies that enable transfer of information other than via wires, or a combination thereof.

Wireless technologies, such as BLUETOOTH and Wireless Fidelity “WI-FI” or variants of WI-FI (e.g. Wi-Fi Direct), enable high speed communications between mobile electronic devices (e.g., cellular phones, watches, headphones, remote controls, etc.) that are within relatively short distances of one another (e.g., 100 to 200 meters or less depending on the specific wireless technology). WI-FI is often used to connect and exchange information between a device with an access point, (e.g. a router) and devices that are WI-FI enabled. Examples of such devices are smart televisions, laptops, thermostats, personal assistant devices, home automation devices, wireless speakers, and other similar devices. Similarly, BLUETOOTH is also used to couple devices together. Examples of such are mobile phones, computers, digital cameras, wireless headsets, keyboards, mice or other input peripherals, and similar devices.

In conjunction with the described implementations, an apparatus includes means for obtaining, at a first device, data associated with a voice transmission during a communication session with a second device. For example, the means for obtaining, at the computing device 102, the communication data 114 of FIG. 1 includes the device 102, the processor(s) 106, the data analyzer 116, the antenna 142, the modem 110, one or more other circuits or components configured to obtain, at a first device, data associated with a voice transmission during a communication session with a second device, or any combination thereof.

The device also includes means for analyzing, at the first device, the data to generate a voice quality metric. For example, the means for analyzing, at the computing device 102, the communication data 114 of FIG. 1 includes the device 102, the processor(s) 106, the data analyzer 116, one or more other circuits or components configured to analyze the communication data 114 to generate a voice quality metric 126, or any combination thereof.

The device also includes, based on a determination that the voice quality metric fails to satisfy a voice quality threshold, means for generating an indication to a user that indicates a manner in which the user should proceed with the communication session. For example, the means for generating the indication 134 of FIG. 1 includes the device 102, the processor(s) 106, the indication generator 118, one or more other circuits or components configured to generate an indication to a user that indicates a manner in which the user should proceed with the communication session, or any combination thereof.

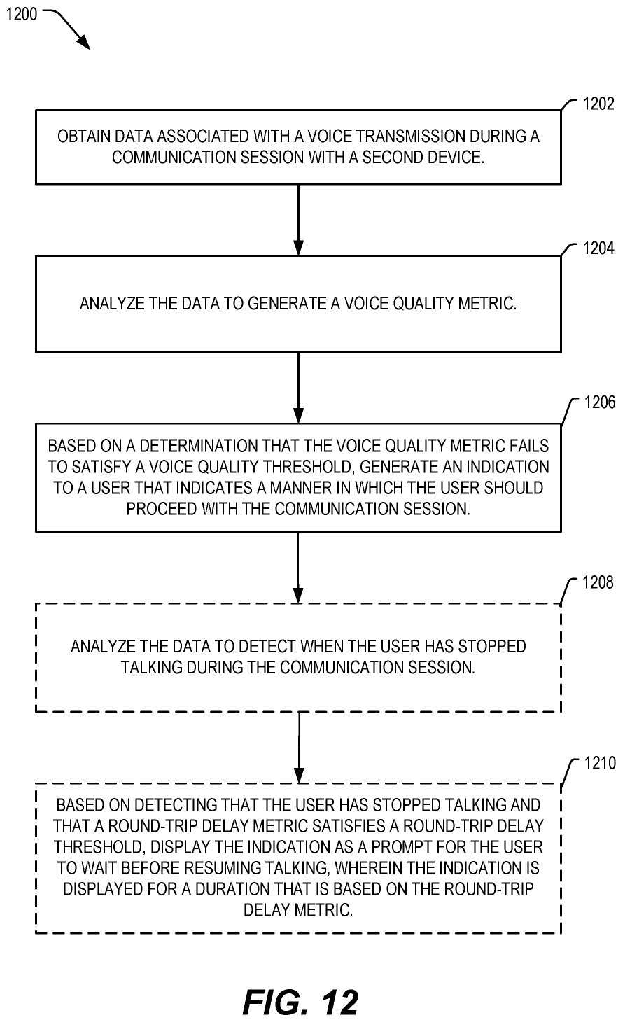

FIG. 12 is a flow chart of an example of a method 1200 for automated user interface alerts for voice quality, in accordance with some examples of the present disclosure. The method 1200 may be initiated, performed, or controlled by one or more processors executing instructions, such as by the processor(s) 106 of FIG. 1 executing instructions 146 from the memory 108.

In some implementations, the method 1200 includes, at block 1202, obtaining, at a first device, data associated with a voice transmission during a communication session with a second device. For example, the processor(s) 106 of FIG. 1 can obtain, at the computing device 102, the communication data 114 associated with a voice transmission during the communication session 112 with the second device 104.

In the example of FIG. 12, the method 1200 includes, at block 1204, analyzing, at the first device, the data to generate a voice quality metric. For example, the processor(s) 106 of FIG. 1 analyzes, at the computing device 102, the communication data 114 to generate the voice quality metric(s) 126.

In the example of FIG. 12, the method 1200 includes, at block 1206, based on a determination that the voice quality metric fails to satisfy a voice quality threshold, generating an indication to a user that indicates a manner in which the user should proceed with the communication session. For example, the processor(s) 106 of FIG. 1 can, based on a determination the voice quality metric 126 fails to satisfy the voice quality threshold 120, generate the indication 134 to a user that indicates a manner in which the user should proceed with the communication session 112, as described in more detail above with reference to FIG. 1.

Although the method 1200 is illustrated as including a certain number of operations, more, fewer, and/or different operations can be included in the method 1200 without departing from the scope of the subject disclosure. For example, the method 1200 can vary depending on the number of second device 104 of FIG. 1 that are involved in the communication session 112

As another example, the method 1200 can optionally include, at block 1208, analyzing the data to detect whether the user has stopped talking during the communication session. For example, the processor(s) 106 of FIG. 1 can analyze the communication data 114 to detect whether the user of the computing device 102 has stopped talking during the communication session 112.

As a further example, the method 1200 can optionally include, at block 1210, based on detecting that the user has stopped talking and that a round-trip delay metric satisfies a round-trip delay threshold, displaying the indication as a prompt for the user to wait before resuming talking, where the indication is displayed for a duration that is based on the round-trip delay metric. For example, the processor(s) 106 of FIG. 1 can, based on detecting that the user of the computing device 102 has stopped talking and that the round-trip delay metric 128 satisfies a round-trip delay threshold, display the indication 134 as a prompt for the user to wait before resuming talking. The indication 134 can be displayed for a duration that is based on the round-trip delay metric 128.

In some implementations, the method 1200 can repeat the operations of one or more of blocks 1202-1206 (or blocks 1202-1208 or blocks 1202-1210) periodically, occasionally, and/or continuously. For example, the method 1200 can obtain, at a first device, data associated with a voice transmission during a communication session with a second device periodically (e.g., every few milliseconds) and analyze, at the first device, the data as it received. The processor(s) 106 of FIG. 1 can be configured to generate the indication 134 only after a certain amount of the communication data 114 is received and analyzed.

Further, although the examples provided above in illustrating method 1200 include the processor(s) 106 of FIG. 1 performing operations of the method 1200, some or all of the operations of the method 1200 can be performed by any suitable computing device.

Further, the operations associated with a method or algorithm described in connection with the implementations disclosed herein, including operations associated with the method 1200 may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

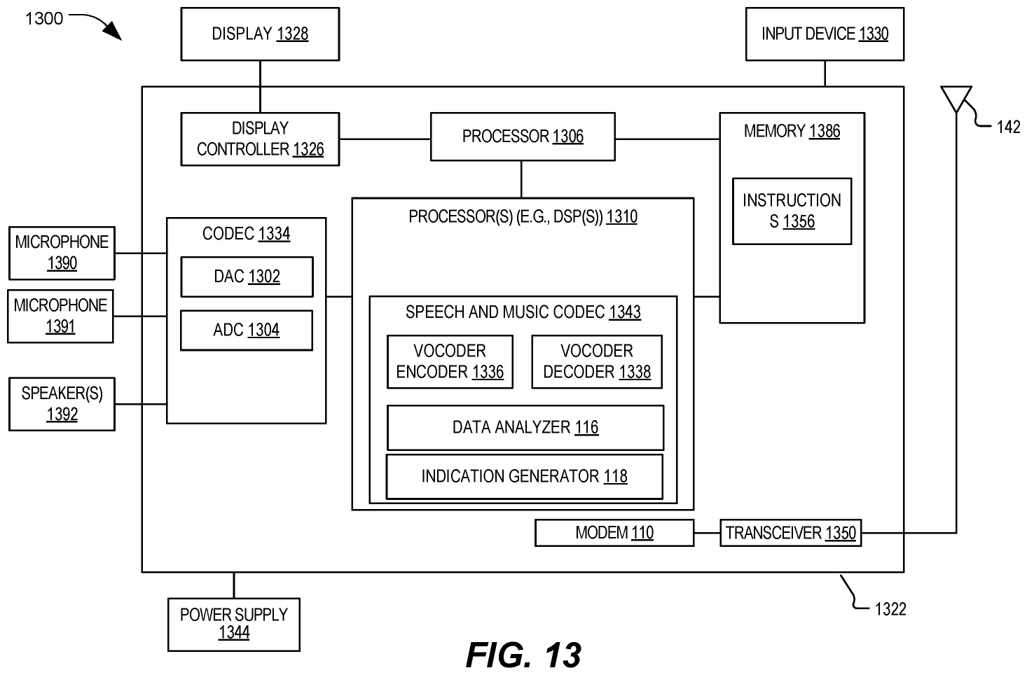

Referring to FIG. 13, a block diagram of a particular illustrative implementation of a device is depicted and generally designated 1300. In various implementations, the device 1300 may have more or fewer components than illustrated in FIG. 13. In an illustrative implementation, the device 1300 may correspond to the computing device 102. In an illustrative implementation, the device 1300 may perform one or more operations described with reference to FIGS. 1-12.

In a particular implementation, the device 1300 includes a processor 1306 (e.g., a central processing unit (CPU)). The device 1300 may include one or more additional processors 1310 (e.g., one or more digital signal processors (DSPs)). In a particular aspect, one or more of the processors 106 of FIG. 1 correspond to the processor 1306, the processors 1310, or a combination thereof. The processor(s) 1310 may include a speech and music coder-decoder (CODEC) 1343 that includes a voice coder (“vocoder”) encoder 1336, a vocoder decoder 1338, the data analyzer 116, the indication generator 118, or a combination thereof.

The device 1300 may include a memory 1386 and a CODEC 1334. The memory 1386 may include instructions 1356, that are executable by the one or more additional processors 1310 (or the processor 1306) to implement the functionality described with reference to the data analyzer 116, the indication generator 118, or some combination thereof. The device 1300 may include the modem 110 coupled, via a transceiver 1350, to the antenna 142.

The device 1300 may include a display 1328 coupled to a display controller 1326. A speaker 1392, a first microphone 1390, and a second microphone 1391 may be coupled to the CODEC 1334. The CODEC 1334 may include a digital-to-analog converter (DAC) 1302, an analog-to-digital converter (ADC) 1304, or both. In a particular implementation, the CODEC 1334 may receive analog signals from the first microphone 1390 and the second microphone 1391, convert the analog signals to digital signals using the analog-to-digital converter 1304, and provide the digital signals to the speech and music codec 1308. The speech and music codec 1308 may process the digital signals, and the digital signals may further be processed by the processor(s) 1310. In a particular implementation, the speech and music codec 1343 may provide digital signals to the CODEC 1334. The CODEC 1334 may convert the digital signals to analog signals using the digital-to-analog converter 1302 and may provide the analog signals to the speaker(s) 1392.

In a particular implementation, the device 1300 may be included in a system-in-package or system-on-chip device 1322. In a particular implementation, the memory 1386, the processor 1306, the processors 1310, the display controller 1326, the CODEC 1334, and the modem 110 are included in the system-in-package or system-on-chip device 1322. In a particular implementation, an input device 1330 and a power supply 1344 are coupled to the system-in-package or the system-on-chip device 1322. Moreover, in a particular implementation, as illustrated in FIG. 13, the display 1328, the input device 1330, the speaker(s) 1392, the first microphone 1390, the second microphone 1391, the antenna 142, and the power supply 1344 are external to the system-in-package or the system-on-chip device 1322. In a particular implementation, each of the display 1328, the input device 1330, the speaker(s) 1392, the first microphone 1390, the second microphone 1391, the antenna 142, and the power supply 1344 may be coupled to a component of the system-in-package or the system-on-chip device 1322, such as an interface (e.g., the wireless interface 132 of FIG. 1) or a controller.

The device 1300 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

Particular aspects of the disclosure are described below in a first set of interrelated examples:

According to Example 1, a device includes one or more processors configured to obtain data associated with a voice transmission during a communication session with a second device. The processor(s) are also configured to analyze the data to generate a voice quality metric. The processor(s) are also configured to, based on a determination that the voice quality metric fails to satisfy a voice quality threshold, generate an indication to a user that indicates a manner in which the user should proceed with the communication session.

Example 2 includes the device of Example 1, wherein the indication includes an alert.

Example 3 includes the device of Example 1 or Example 2, wherein the alert includes an audio alert, a visual alert, a haptic alert, or a combination thereof.

Example 4 includes the device of any of Examples 1 to 3, wherein the indication includes an instruction to inform the user of the manner in which the user should proceed.

Example 5 includes the device of Example 4, wherein the instruction includes an instruction associated with transmission of additional audio data from the device.

Example 6 includes the device of Example 4 or Example 5, wherein the instruction includes an instruction for the user to delay transmission of additional audio data from the device.

Example 7 includes the device of any of Examples 4 to 6, wherein the instruction includes an instruction for the user to extend a period of nontransmission of audio data from the device.

Example 8 includes the device of any of Examples 4 to 7, wherein the instruction is based on a type of user activity.

Example 9 includes the device of Example 8, wherein the type of user activity is a video call, a video game, or an audio call.

Example 10 includes the device of any of Examples 1 to 9, wherein the voice quality metric includes a round-trip delay metric and the voice quality threshold corresponds to a round-trip delay threshold. The one or more processors are configured to analyze the data to detect when the user has stopped talking during the communication session. The one or more processors are also configured to, based on detecting that the user has stopped talking and that the round-trip delay metric satisfies the round-trip delay threshold, display the indication as a prompt for the user to wait before resuming talking, wherein the indication is displayed for a duration that is based on the round-trip delay metric.

Example 11 includes the device of Example 10, wherein the duration is also based on a user-specific buffer period, the user-specific buffer period based on at least one of a response time of the user or a communication session configuration for the user.

Example 12 includes the device of Example 10 or Example 11, wherein the round-trip delay metric is based on a time between a last transmitted packet from the device to a second device and a first received voice packet at the device from the second device, in addition to a response time associated with the second device. The response time associated with the second device is based on a time elapsed between a last received packet at the second device from the device and a first transmitted packet at the second device to the device following the last received packet.

Example 13 includes the device of any of Examples 1 to 12, wherein the one or more processors are configured to analyze the data according to a block error rate (BLER) metric or a signal-to-noise ratio (SNR) metric.

Example 14 includes the device of any of Examples 1 to 13, wherein the one or more processors are configured to analyze the data according to a packet delay metric.

Example 15 includes the device of Example 14, wherein the packet delay metric includes a number of hybrid automatic repeat request (HARQ) retransmissions, a radio link control (RLC) retransmission metric, or an end-to-end packet delay metric.

Example 16 includes the device of any of Examples 1 to 15, wherein the voice quality metric includes a number of packet retransmissions and the voice quality threshold corresponds a retransmission threshold. The one or more processors are configured to analyze the data to determine the number of packet retransmissions. The one or more processors are also configured to, if the number of packet retransmissions satisfies the retransmission threshold, generate the indication to the user.

Example 17 includes the device of Example 16, wherein the indication includes an alert to the user to adjust to a higher delay scenario.

Example 18 includes the device of Example 16 or Example 17, wherein the retransmission threshold is based at least on a number of packet retransmissions during a packet window.

Example 19 includes the device of Example 18, wherein the packet window includes a quantity of most recently transmitted packets of a 5G communication session and the retransmission threshold is satisfied based on retransmission of a portion of the quantity of most recently transmitted packets.

Example 20 includes the device of any of Examples 16 to 19, wherein the retransmission threshold varies based on a numerology associated with the communication session.

Example 21 includes the device of any of Examples 1 to 20, wherein the one or more processors are configured to analyze the data according to a signal quality metric that does not require a reference signal.

Example 22 includes the device of Example 21, wherein the signal quality metric includes an auditory non-intrusive quality estimation metric.

Example 23 includes the device of any of Examples 1 to 22, wherein the indication is based on the voice quality metric.

Example 24 includes the device of any of Examples 1 to 23, wherein the data is associated with an over-the-top voice link.

Example 25 includes the device of any of Examples 1 to 24, wherein the data is associated with a text-to-speech voice data source.

Example 26 includes the device of any of Examples 1 to 25 and further includes a modem configured to receive the voice transmission.

Example 27 includes the device of any of Examples 1 to 26 and further includes one or more of a speaker configured to provide the indication via an audible signal, a haptic device configured to provide the indication via a haptic signal, and a display device configured to provide the indication via a visual signal.

Example 28 includes the device of any of Examples 1 to 27 and further includes a microphone configured to receive a voice signal from the user.

Example 29 includes the device of any of Examples 1 to 29, wherein the one or more processors are configured to communicate the indication from the device to the second device.

Example 30 includes the device of Example 29, wherein the one or more processors are configured to generate the indication based on a second indication received from the second device.

According to Example 31, a non-transitory computer-readable medium comprises instructions that, when executed by one or more processors, cause the one or more processors to obtain, at a first device, data associated with a voice transmission during a communication session with a second device. The instructions, when executed by the one or more processors, also cause the one or more processors to analyze, at the first device, the data to generate a voice quality metric. The instructions, when executed by the one or more processors, also cause the one or more processors to, based on a determination that the voice quality metric fails to satisfy a voice quality threshold, generate an indication to a user that indicates a manner in which the user should proceed with the communication session.

Example 32 includes the non-transitory computer-readable medium of Example 31, wherein the indication includes an alert.

Example 33 includes the non-transitory computer-readable medium of Example 31 or Example 32, wherein the alert includes an audio alert, a visual alert, a haptic alert, or a combination thereof.

Example 34 includes the non-transitory computer-readable medium of any of Examples 31 to 33, wherein the indication includes an instruction to inform the user of the manner in which the user should proceed.

Example 35 includes the non-transitory computer-readable medium of Example 34, wherein the instruction includes an instruction associated with transmission of additional audio data from the non-transitory computer-readable medium.

Example 36 includes the non-transitory computer-readable medium of Example 34 or Example 35, wherein the instruction includes an instruction for the user to delay transmission of additional audio data from the non-transitory computer-readable medium.

Example 37 includes the non-transitory computer-readable medium of any of Examples 34 to 36, wherein the instruction includes an instruction for the user to extend a period of nontransmission of audio data from the non-transitory computer-readable medium.

Example 38 includes the non-transitory computer-readable medium of any of Examples 34 to 37, wherein the instruction is based on a type of user activity.

Example 39 includes the non-transitory computer-readable medium of Example 39, wherein the type of user activity is a video call, a video game, or an audio call.

Example 40 includes the non-transitory computer-readable medium of any of Examples 31 to 39, wherein the voice quality metric includes a round-trip delay metric and the voice quality threshold corresponds to a round-trip delay threshold. The instructions, when executed by the one or more processors, also cause the one or more processors to analyze the data to detect when the user has stopped talking during the communication session and, based on detecting that the user has stopped talking and that the round-trip delay metric satisfies the round-trip delay threshold, display the indication as a prompt for the user to wait before resuming talking, wherein the indication is displayed for a duration that is based on the round-trip delay metric.

Example 41 includes the non-transitory computer-readable medium of Example 40, wherein the duration is also based on a user-specific buffer period, the user-specific buffer period based on at least one of a response time of the user or a communication session configuration for the user.

Example 42 includes the non-transitory computer-readable medium of Example 40 or Example 41, wherein the round-trip delay metric is based on a time between a last transmitted packet from the first device to a second device and a first received voice packet at the device from the second device, in addition to a response time associated with the second device. The response time associated with the second device is based on a time elapsed between a last received packet at the second device from the first device and a first transmitted packet at the second device to the first device following the last received packet.

Example 43 includes the non-transitory computer-readable medium of any of Examples 31 to 42, wherein the one or more processors are configured to analyze the data according to a block error rate (BLER) metric or a signal-to-noise ratio (SNR) metric.

Example 44 includes the non-transitory computer-readable medium of any of Examples 31 to 43, wherein the one or more processors are configured to analyze the data according to a packet delay metric.

Example 45 includes the non-transitory computer-readable medium of Example 44, wherein the packet delay metric includes a number of hybrid automatic repeat request (HARQ) retransmissions, a radio link control (RLC) retransmission metric, or an end-to-end packet delay metric.

Example 46 includes the non-transitory computer-readable medium of any of Examples 31 to 45, wherein the voice quality metric includes a number of packet retransmissions; the voice quality threshold corresponds a retransmission threshold and the one or more processors are configured to analyze the data to determine the number of packet retransmissions. The instructions, when executed by the one or more processors, also cause the one or more processors to, if the number of packet retransmissions satisfies the retransmission threshold, generate the indication to the user.

Example 47 includes the non-transitory computer-readable medium of Example 46, wherein the indication includes an alert to the user to adjust to a higher delay scenario.

Example 48 includes the non-transitory computer-readable medium of Example 46 or Example 47, wherein the retransmission threshold is based at least on a number of packet retransmissions during a packet window.

Example 49 includes the non-transitory computer-readable medium of Example 48, wherein the packet window includes a quantity of most recently transmitted packets of a 5G communication session and the retransmission threshold is satisfied based on retransmission of a portion of the quantity of most recently transmitted packets.

Example 50 includes the non-transitory computer-readable medium of any of Examples 46 to 49, wherein the retransmission threshold varies based on a numerology associated with the communication session.

Example 51 includes the non-transitory computer-readable medium of any of Examples 31 to 50, wherein the one or more processors are configured to analyze the data according to a signal quality metric that does not require a reference signal.

Example 52 includes the non-transitory computer-readable medium of Example 51, wherein the signal quality metric includes an auditory non-intrusive quality estimation metric.

Example 53 includes the non-transitory computer-readable medium of any of Examples 31 to 52, wherein the indication is based on the voice quality metric.

Example 54 includes the non-transitory computer-readable medium of any of Examples 31 to 53, wherein the data is associated with an over-the-top voice link.

Example 55 includes the non-transitory computer-readable medium of any of Examples 31 to 54, wherein the data is associated with a text-to-speech voice data source.

Example 56 includes the non-transitory computer-readable medium of any of Examples 31 to 55, wherein the one or more processors are configured to obtain data associated with the voice transmission from a modem configured to receive the voice transmission.

Example 57 includes the non-transitory computer-readable medium of any of Examples 31 to 56 and further includes one or more of a speaker configured to provide the indication via an audible signal, a haptic device configured to provide the indication via a haptic signal, and a display device configured to provide the indication via a visual signal.

Example 58 includes the non-transitory computer-readable medium of any of Examples 31 to 57 and further includes a microphone configured to receive a voice signal from the user.

Example 59 includes the non-transitory computer-readable medium of any of Examples 31 to 58, wherein the one or more processors are configured to communicate the indication from the first device to the second device.

Example 60 includes the non-transitory computer-readable medium of Example 59, wherein the one or more processors are configured to generate the indication based on a second indication received from the second device.

According to Example 61, a method includes obtaining, at a first device, data associated with a voice transmission during a communication session with a second device. The method also includes analyzing, at the first device, the data to generate a voice quality metric. The method also includes, based on a determination that the voice quality metric fails to satisfy a voice quality threshold, generating an indication to a user that indicates a manner in which the user should proceed with the communication session.

Example 62 includes the method of Example 61, wherein the indication includes an alert.

Example 63 includes the method of Example 61 or Example 62, wherein the alert includes an audio alert, a visual alert, a haptic alert, or a combination thereof.

Example 64 includes the method of any of Examples 61 to 63, wherein the indication includes an instruction to inform the user of the manner in which the user should proceed.

Example 65 includes the method of Example 64, wherein the instruction includes an instruction associated with transmission of additional audio data from the method.

Example 66 includes the method of Example 64 or Example 65, wherein the instruction includes an instruction for the user to delay transmission of additional audio data from the method.

Example 67 includes the method of any of Examples 64 to 66, wherein the instruction includes an instruction for the user to extend a period of nontransmission of audio data from the method.

Example 68 includes the method of any of Examples 64 to 67, wherein the instruction is based on a type of user activity.

Example 69 includes the method of Example 68, wherein the type of user activity is a video call, a video game, or an audio call.

Example 70 includes the method of any of Examples 61 to 69, wherein the voice quality metric includes a round-trip delay metric and the voice quality threshold corresponds to a round-trip delay threshold. The method further includes analyzing the data to detect when the user has stopped talking during the communication session, and, based on detecting that the user has stopped talking and that the round-trip delay metric satisfies the round-trip delay threshold, displaying the indication as a prompt for the user to wait before resuming talking, wherein the indication is displayed for a duration that is based on the round-trip delay metric.

Example 71 includes the method of Example 70, wherein the duration is also based on a user-specific buffer period, the user-specific buffer period based on at least one of a response time of the user or a communication session configuration for the user.

Example 72 includes the method of Example 70 or Example 71, wherein the round-trip delay metric is based on a time between a last transmitted packet from the first device to a second device and a first received voice packet at the device from the second device, in addition to a response time associated with the second device. The response time associated with the second device is based on a time elapsed between a last received packet at the second device from the first device and a first transmitted packet at the second device to the first device following the last received packet.

Example 73 includes the method of any of Examples 61 to 72, wherein analyzing the data comprises analyzing the data according to a block error rate (BLER) metric or a signal-to-noise ratio (SNR) metric.

Example 74 includes the method of any of Examples 61 to 73, wherein analyzing the data comprises analyzing the data according to a packet delay metric.

Example 75 includes the method of Example 74, wherein the packet delay metric includes a number of hybrid automatic repeat request (HARQ) retransmissions, a radio link control (RLC) retransmission metric, or an end-to-end packet delay metric.

Example 76 includes the method of any of Examples 61 to 75, wherein the voice quality metric includes a number of packet retransmissions and the voice quality threshold corresponds a retransmission threshold. The method further includes analyzing the data to determine the number of packet retransmissions; and if the number of packet retransmissions satisfies the retransmission threshold, generating the indication to the user.

Example 77 includes the method of Example 76, wherein the indication includes an alert to the user to adjust to a higher delay scenario.

Example 78 includes the method of Example 76 or Example 77, wherein the retransmission threshold is based at least on a number of packet retransmissions during a packet window.

Example 79 includes the method of Example 78, wherein the packet window includes a quantity of most recently transmitted packets of a 5G communication session and the retransmission threshold is satisfied based on retransmission of a portion of the quantity of most recently transmitted packets.

Example 80 includes the method of any of Examples 76 to 79, wherein the retransmission threshold varies based on a numerology associated with the communication session.

Example 81 includes the method of any of Examples 61 to 80, wherein analyzing the data comprises analyzing the data according to a signal quality metric that does not require a reference signal.

Example 82 includes the method of Example 81, wherein the signal quality metric includes an auditory non-intrusive quality estimation metric.

Example 83 includes the method of any of Examples 61 to 82, wherein the indication is based on the voice quality metric.

Example 84 includes the method of any of Examples 61 to 83, wherein the data is associated with an over-the-top voice link.

Example 85 includes the method of any of Examples 61 to 84, wherein the data is associated with a text-to-speech voice data source.

According to Example 86, an apparatus includes means for obtaining, at a first device, data associated with a voice transmission during a communication session with a second apparatus. The apparatus also includes means for analyzing, at the first device, the data to generate a voice quality metric. The apparatus also includes means for, based on a determination that the voice quality metric fails to satisfy a voice quality threshold, generating an indication to a user that indicates a manner in which the user should proceed with the communication session.

Example 87 includes the apparatus of Example 86, wherein the indication includes an alert.

Example 88 includes the apparatus of Example 86 or Example 87, wherein the alert includes an audio alert, a visual alert, a haptic alert, or a combination thereof.

Example 89 includes the apparatus of any of Examples 86 to 88, wherein the indication includes an instruction to inform the user of the manner in which the user should proceed.

Example 90 includes the apparatus of Example 89, wherein the instruction includes an instruction associated with transmission of additional audio data from the apparatus.

Example 91 includes the apparatus of Example 89 or Example 90, wherein the instruction includes an instruction for the user to delay transmission of additional audio data from the apparatus.

Example 92 includes the apparatus of any of Examples 89 to 91, wherein the instruction includes an instruction for the user to extend a period of nontransmission of audio data from the apparatus.

Example 93 includes the apparatus of any of Examples 89 to 92, wherein the instruction is based on a type of user activity.

Example 94 includes the apparatus of Example 93, wherein the type of user activity is a video call, a video game, or an audio call.

Example 95 includes the apparatus of any of Examples 86 to 94, wherein the voice quality metric includes a round-trip delay metric and the voice quality threshold corresponds to a round-trip delay threshold. The apparatus further includes means for analyzing the data to detect when the user has stopped talking during the communication session and based on detecting that the user has stopped talking and that the round-trip delay metric satisfies the round-trip delay threshold, means for displaying the indication as a prompt for the user to wait before resuming talking, wherein the indication is displayed for a duration that is based on the round-trip delay metric.

Example 96 includes the apparatus of Example 95, wherein the duration is also based on a user-specific buffer period, the user-specific buffer period based on at least one of a response time of the user or a communication session configuration for the user.

Example 97 includes the apparatus of Example 95 or Example 96, wherein the round-trip delay metric is based on a time between a last transmitted packet from the device to a second device and a first received voice packet at the first device from the second device, in addition to a response time associated with the second device. The response time associated with the second device is based on a time elapsed between a last received packet at the second device from the first device and a first transmitted packet at the second device to the first device following the last received packet.

Example 98 includes the apparatus of any of Examples 86 to 97, wherein analyzing the data comprises analyzing the data according to a block error rate (BLER) metric or a signal-to-noise ratio (SNR) metric.

Example 99 includes the apparatus of any of Examples 86 to 98, wherein analyzing the data comprises analyzing the data according to a packet delay metric.

Example 100 includes the apparatus of Example 99, wherein the packet delay metric includes a number of hybrid automatic repeat request (HARQ) retransmissions, a radio link control (RLC) retransmission metric, or an end-to-end packet delay metric.

Example 101 includes the apparatus of any of Examples 86 to 100, wherein the voice quality metric includes a number of packet retransmissions and the voice quality threshold corresponds a retransmission threshold. The apparatus further includes means for analyzing the data to determine the number of packet retransmissions and, if the number of packet retransmissions satisfies the retransmission threshold, means for generating the indication to the user.

Example 102 includes the apparatus of Example 101, wherein the indication includes an alert to the user to adjust to a higher delay scenario.

Example 103 includes the apparatus of Example 101 or Example 102, wherein the retransmission threshold is based at least on a number of packet retransmissions during a packet window.

Example 104 includes the apparatus of Example 103, wherein the packet window includes a quantity of most recently transmitted packets of a 5G communication session and the retransmission threshold is satisfied based on retransmission of a portion of the quantity of most recently transmitted packets.

Example 105 includes the apparatus of any of Examples 101 to 104, wherein the retransmission threshold varies based on a numerology associated with the communication session.

Example 106 includes the apparatus of Example 105, wherein analyzing the data comprises analyzing the data according to a signal quality metric that does not require a reference signal.

Example 107 includes the apparatus of Example 106, wherein the signal quality metric includes an auditory non-intrusive quality estimation metric.

Example 108 includes the apparatus of any of Examples 86 to 107, wherein the indication is based on the voice quality metric.

Example 109 includes the apparatus of any of Examples 86 to 108, wherein the data is associated with an over-the-top voice link.

Example 110 includes the apparatus of any of Examples 86 to 109, wherein the data is associated with a text-to-speech voice data source.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
one or more processors configured to:
obtain data associated with a voice transmission during a communication session with a second device;
analyze the data to generate a voice quality metric; and
based on a determination that the voice quality metric fails to satisfy a voice quality threshold, generate an indication to a user that indicates a manner in which the user should proceed with the communication session.

2. The device of claim 1, wherein the indication includes an alert.

3. The device of claim 2, wherein the alert includes an audio alert, a visual alert, a haptic alert, or a combination thereof.

4. The device of claim 1, wherein the indication includes an instruction to inform the user of the manner in which the user should proceed.

5. The device of claim 4, wherein the instruction includes an instruction associated with transmission of additional audio data from the device.

6. The device of claim 4, wherein the instruction includes an instruction for the user to delay transmission of additional audio data from the device.

7. The device of claim 4, wherein the instruction includes an instruction for the user to extend a period of nontransmission of audio data from the device.

8. The device of claim 4, wherein the instruction is based on a type of user activity.

9. The device of claim 8, wherein the type of user activity is a video call, a video game, or an audio call.

10. The device of claim 1, wherein:
the voice quality metric includes a round-trip delay metric;
the voice quality threshold corresponds to a round-trip delay threshold; and
the one or more processors are configured to:
analyze the data to detect when the user has stopped talking during the communication session; and
based on detecting that the user has stopped talking and that the round-trip delay metric fails to satisfy the round-trip delay threshold, display the indication as a prompt for the user to wait before resuming talking, wherein the indication is displayed for a duration that is based on the round-trip delay metric.

11. The device of claim 10, wherein the duration is also based on a user-specific buffer period, the user-specific buffer period based on at least one of a response time of the user or a communication session configuration for the user.

12. The device of claim 10, wherein:
the round-trip delay metric is based on a time between a last transmitted packet from the device to the second device and a first received voice packet at the device from the second device, in addition to a response time associated with the second device; and
the response time associated with the second device is based on a time elapsed between a last received packet at the second device from the device and a first transmitted packet at the second device to the device following the last received packet.

13. The device of claim 1, wherein the one or more processors are configured to analyze the data according to a block error rate (BLER) metric or a signal-to-noise ratio (SNR) metric.

14. The device of claim 1, wherein the one or more processors are configured to analyze the data according to a packet delay metric.

15. The device of claim 14, wherein the packet delay metric includes a number of hybrid automatic repeat request (HARQ) retransmissions, a radio link control (RLC) retransmission metric, or an end-to-end packet delay metric.

16. The device of claim 1, wherein:
the voice quality metric includes a number of packet retransmissions;
the voice quality threshold corresponds a retransmission threshold; and
the one or more processors are configured to:
analyze the data to determine the number of packet retransmissions; and
if the number of packet retransmissions exceeds the retransmission threshold, generate the indication to the user.

17. The device of claim 16, wherein the indication includes an alert to the user to adjust to a higher delay scenario.

18. The device of claim 16, wherein the retransmission threshold is based at least on a number of packet retransmissions during a packet window.

19. The device of claim 18, wherein:
the packet window includes a quantity of most recently transmitted packets of a 5G communication session; and
the retransmission threshold is satisfied based on retransmission of a portion of the quantity of most recently transmitted packets.

20. The device of claim 16, wherein the retransmission threshold varies based on a numerology associated with the communication session.

21. The device of claim 1, wherein the one or more processors are configured to analyze the data according to a signal quality metric that does not require a reference signal.

22. The device of claim 21, wherein the signal quality metric includes an auditory non-intrusive quality estimation metric.

23. The device of claim 1, wherein the indication is based on the voice quality metric.

24. The device of claim 1, wherein the data is associated with an over-the-top voice link.

25. The device of claim 1, wherein the data is associated with a text-to-speech voice data source.

26. The device of claim 1, further comprising a speaker configured to provide the indication via an audible signal.

27. The device of claim 1, further comprising a haptic device configured to provide the indication via a haptic signal.

28. The device of claim 1, further comprising a display device configured to provide the indication via a visual signal.

29. The device of claim 1, wherein the one or more processors are configured to communicate the indication from the device to the second device.

30. The device of claim 29, wherein the one or more processors are configured to generate the indication based on a second indication received from the second device.
